(19) United States
(12) Patent Application Publication
(10) Pub. No.: US 2016/0358127 A1
(43) Pub. Date: Dec. 8, 2016

(54) UNDELETE CALENDARS

(71) Applicant: APPLE INC., Cupertino, CA (US)

(72) Inventors: Cyrus Daboo, Cupertino, CA (US); Morgen Sagen, Cupertino, CA (US); Wilfredo Sanchez, Cupertino, CA (US)

(21) Appl. No.: 14/732,508

(22) Filed: Jun. 5, 2015

(51) Int. Cl. G06Q 10/10

(52) U.S. Cl. CPC G06Q 10/1095

(57) ABSTRACT

A first calendar of a first user can be stored in a database system. The first calendar may include a plurality of event records. A delete command may be received to delete at least a first portion of the first calendar. The at least a first portion of the first calendar may be marked as deleted by one or more flags. After marking, the at least a first portion of the first calendar may be updated in response to a change made to a second event record of a second calendar of a second user. A recover command may be received to recover the at least a portion of the first calendar. The one or more flags may be changed to indicate that the at least a portion of the first calendar is not deleted. The first event record may be provided to the first user with the changed information.

### BACKGROUND

Modern day professionals attend meetings on a regular basis. Each meeting typically has a scheduled meeting time, location, and list of attendees. The professional needs to keep track of these meetings so that they are not missed. Often times, the sheer number of planned meetings makes it difficult to manage the details of all the meetings. One way to keep track of all the meetings is with the use of calendars. Calendars are a graphical arrangement of days and months in a year. They can provide a user interface that allows the professional to enter in and store the details of each scheduled meeting. In many instances, several tens or even hundreds of scheduled meetings can be stored on one calendar. Thus, calendars may be very important tools for a modern day professional. Such a reliance on calendars can cause havoc if a calendar is deleted.

### BRIEF SUMMARY

Embodiments provide improved devices and methods for undeleting calendars. For instance, if a calendar is deleted, the calendar can be recovered as if the calendar was not deleted. In an embodiment, when a calendar is deleted, the calendar can be marked in a database as deleted and hidden from view. When hidden, changes to the calendar (e.g., event records within the calendar) may still occur as if the calendar still existed. The calendar may be recovered by removing the mark (e.g., changing a flag) and having the calendar re-appear. The recovered calendar may include all updates made while the calendar was hidden such that the recovered calendar can inform the user of the most up-to-date scheduled events.

In some embodiments, a calendar is stored in a database system. The calendar may include a plurality of event records containing information about an event location, event attendees, and an event time. A delete command may be received to delete at least a portion of the calendar. Once the delete command is received, at least a portion of the calendar is marked as deleted using one or more flags such that the at least a portion of the calendar is not accessible to a user. While the at least a portion of the calendar is marked as deleted, an update to a first event record may be received. The update may be in response to a change made to a second event record of another calendar. The second event record may correspond to the first event record. The information of the first event record may be changed using the update. Once the first event record is changed, a recover command may be received to recover the at least a portion of the first calendar. The one or more flags may be changed to indicate that the at least a portion of the first calendar is not deleted. In response to a request to view the first event record, the first event record may be provided to the user with the changed information.

Other embodiments are directed to systems, portable consumer devices, and computer readable media associated with methods described herein.

A better understanding of the nature and advantages of embodiments of the present invention may be gained with reference to the following detailed description and the accompanying drawings.

### BRIEF DESCRIPTION OF THE DRAWINGS

FIG. 1 is a flow chart for a method of undeleting a calendar according to embodiments of the present invention.

FIG. 2 shows a block diagram of an exemplary calendar according to embodiments of the present invention.

FIG. 3 shows a block diagram of a system for within which calendars are created according to embodiments of the present invention.

FIG. 4 shows a block diagram of a system for deleting a calendar by marking that is initiated by an organizer according to embodiments of the present invention.

FIG. 5 shows a block diagram of a system for deleting a calendar by marking that is initiated by an invitee according to embodiments of the present invention.

FIG. 6 shows a block diagram of a system for deleting a calendar by moving that is initiated by an organizer according to embodiments of the present invention.

FIG. 7 shows a block diagram of a system for updating a calendar according to embodiments of the present invention.

FIG. 8 shows a block diagram of a system for restoring a calendar by marking according to embodiments of the present invention.

FIG. 9 shows a block diagram of a system for restoring a calendar by moving according to embodiments of the present invention.

FIG. 10 shows a block diagram of a system for restoring an event record based upon priority according to embodiments of the present invention.

FIG. 11 is a flow chart for a method of undeleting a calendar according to embodiments of the present invention.

FIG. 12 is a block diagram of an example device according to embodiments of the present invention.

### DETAILED DESCRIPTION

Calendars may contain numerous event records. Each event record may correspond to a scheduled event, such as a meeting, and may contain a variety of useful information, e.g., event time, event location, and event attendees. When a calendar is deleted, all the event records may be deleted as well. This may be particularly devastating when the calendar is deleted by accident. In such instances, the user may want to recover the calendar as soon as possible. The process of restoring the calendar may include contacting the company's service department, such as the company's Information Technology (IT) department, to ask them to locate the deleted calendar and recover it for the user. Often times this process is stressful and time consuming. Additionally, if the event records are updated (i.e., changed) while the calendar is deleted, the recovered calendar will not reflect the updates. Thus, the user may be unaware that the calendar contains incorrect information, causing him or her to miss the event.

In some instances, a user may not have to contact IT and wait for them to locate and recover his or her calendar. Instead, the user may recover the calendar by uploading a backed-up calendar. The user may be able to personally recover the deleted calendar in a reasonable amount of time with less stress. However, this method of restoring a deleted calendar requires the user to constantly back up his or her hard drive, which is typically not done on a regular basis. Additionally, this method requires that the calendar be backed up often enough such that when the user needs to recover a calendar, the calendar is relatively up-to-date. The backed-up calendar may be stored on a separate hard drive that is not accessible to the company's computer system. Thus, like the method of contacting IT, the calendar cannot be updated when deleted, resulting in the recovered calendar containing incorrect event information that is not useful.

Embodiments of the present invention provide a method of allowing a user to personally recover a calendar, and have the recovered calendar be up-to-date with correct event information. For instance, a calendar may be deleted by the user. If an event record of the deleted calendar is changed, by an organizer for example, then the event record may be updated to reflect that change, even though the calendar is deleted, i.e., inaccessible to the user. Thus, when the calendar is recovered, the recovered calendar will include the changed event information.

Being able to personally recover an up-to-date calendar has several benefits. A recovered calendar that is up-to-date minimizes the risk of the user missing the event. The user may have complete confidence in his or her recovered calendar. Additionally, the user does not have to waste time in contacting IT. Instead, the user can personally recover the deleted calendar in a fraction of the time typically required when going through IT. Moreover, the user does not have to constantly back up his calendar onto a hard drive, hoping that his hard drive has the most up-to-date calendar if the calendar were to be accidentally deleted.

### I. Overview for Undeleting Calendars

Embodiments allow a user to recover (e.g., personally or via an administrator) a calendar as if the calendar was not deleted in the first place (e.g., “undeleting” the calendar). For instance, when the calendar is deleted, updates to the deleted calendar may still be made. Updates may include any change to an event record of the calendar, such as, but not limited to, a change in the location of the meeting, a change in the meeting time, or a change in the number of participants. When the calendar is recovered, the recovered calendar will include any changes made to the meeting while the calendar was deleted.

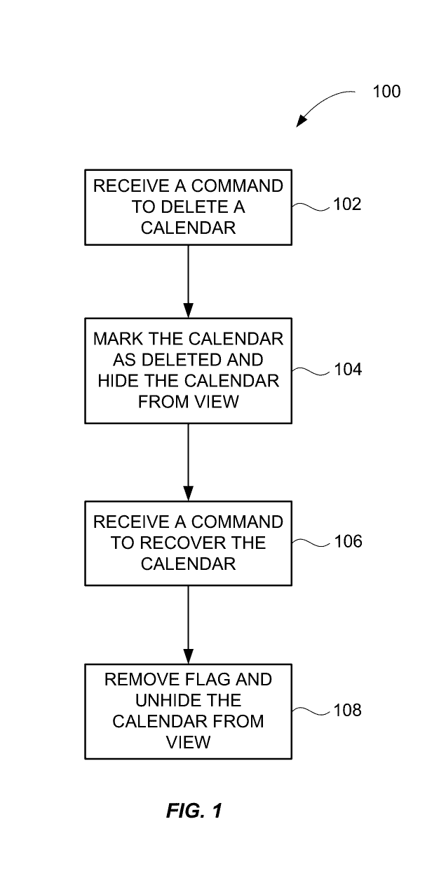

FIG. 1 is a flow chart of a method 100 for undeleting a calendar according to embodiments of the present invention. Method 100 can be performed by a mobile device (e.g., a phone, tablet) or a non-mobile device (e.g., a desktop computer).

At block 102, a command to delete a calendar is received by a calendar application. The calendar application may be a computer program that can perform functions to undelete calendars according to embodiments of the present invention. In some embodiments, a user that is interacting with a user interface of a computer can send a command to delete the calendar. As a non-limiting example, the command may be sent by pressing the “delete” key on the keyboard when the calendar is selected. The calendar application may reside partially on a client computer and on a server computer, e.g., which backs up and stores the calendar such that the user can access the calendar from other devices. The calendar application can also operate on the server, and receive commands from code running on a client computer. The server may store a user's calendar in a database.

At block 104, the calendar may be marked by the calendar application to indicate that the calendar is deleted. Marking the calendar may be performed by any suitable method for indicating that the calendar is deleted. The calendar may be marked in a database at a server. For instance, the calendar may be marked by changing a flag from “1” to “0.” A flag set at “1” may indicate that the calendar is not deleted and therefore accessible to the user. A flag set to “0,” on the other hand, may indicate that the calendar is deleted and thus not accessible to the user. In addition to marking the calendar, the calendar can also be hidden to prevent the user from viewing the calendar. Preventing accessibility to the user makes the calendar appear to be deleted.

At block 106, a command to recover the calendar may be received by the calendar application. In embodiments, the user may interact with the user interface of the computer to send a command to recover the calendar. For instance, the user may select the deleted calendar and click “recover” in a web browser.

At block 108, the deleted calendar may be recovered by removing the marker. If the marker is a flag, as aforementioned herein, then the flag may be changed back to “1,” indicating that the calendar is recovered and rendered accessible to the user (i.e., undeleted). By removing the marker, the calendar can re-appear when the user synchronizes his computer to a server containing the calendar in a database. In embodiments, the recovered calendar may contain event records that have been updated while the calendar was deleted, as will be discussed in further detail herein.

### II. Creating Calendars

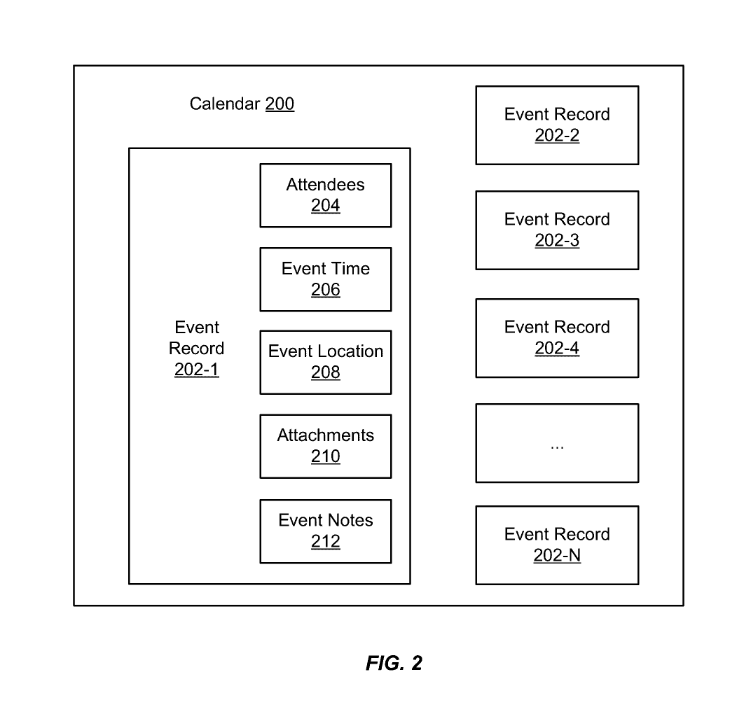

In order to understand how calendars are undeleted, it may be important to understand what calendars contain and how calendars are created. FIG. 2 illustrates an exemplary calendar 200, according to embodiments of the present invention. Calendar 200 may be a collection of data that is stored in a database. In embodiments, calendar 200 contains a plurality of event records 202. For instance, calendar 200 may contain N event records 202, ranging from 202-1 to 202-N. Each event record 202 may correspond to a single scheduled event, such as a meeting or an appointment. Additionally, each event record 202 may include data that pertains to the details of the scheduled event.

As an example, the event record 202-1 may include data pertaining to attendees 204, event time 206, event location 208, attachments 210, and event notes 212, as illustrated in FIG. 2. Attendees 204 can by any person that is scheduled to attend the meeting. For instance, in a business environment, attendees 204 may be employees, such as engineers, managers, directors, executives, etc. Event time 206 may correspond to a date and time of day when the meeting will occur. Event location 208 may correspond to where the meeting will take place, e.g., in a specific conference room, in an employee's office, or even at a specific address. Attachments 210 may correspond to separate files and/or documents that will be needed to supplement the discussion. For instance, attachments 210 may be a Numbers spreadsheet, a Pages document, or a Keynote presentation. Event notes 212 may correspond to any other additional information that may be useful to the attendees 204, e.g., text that reminds attendees to be cognizant of their noise level during the meeting to not disturb neighboring conference rooms.

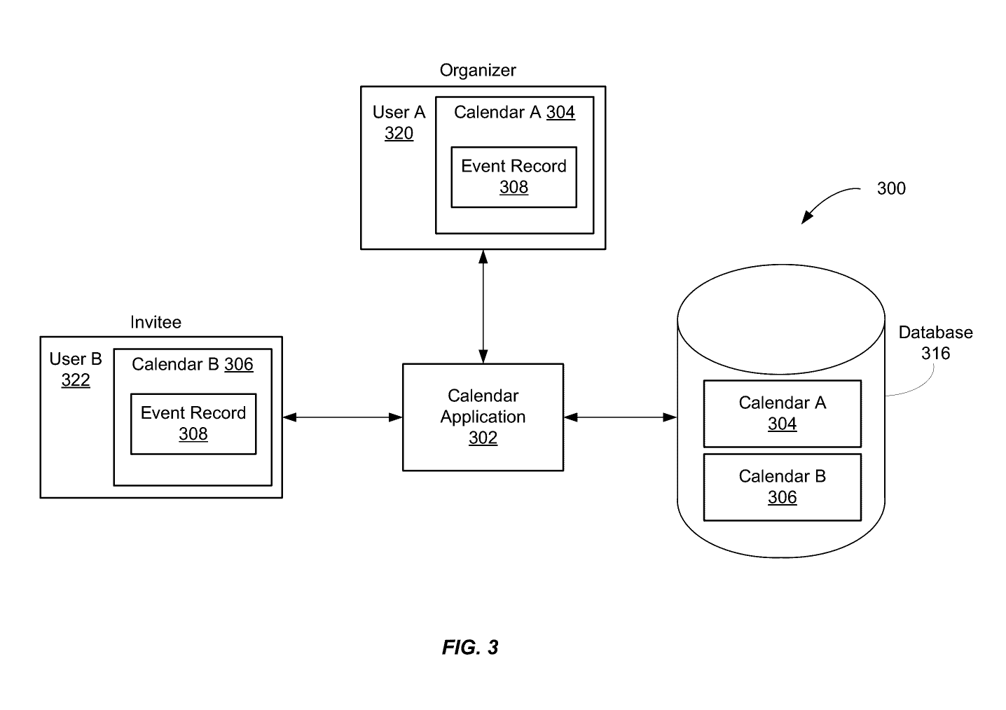

FIG. 3 is a block diagram of a system 300 within which calendars are created, according to embodiments of the present invention. System 300 may include a calendar application 302 and a database 316. System 300 may interact with users, such as user A 320 and user B 322. Calendar application 302 may be a computer program that is commonly run on computers for both users. In embodiments, calendar application 302 is operable to allow interaction between calendars of user A and user B, and the database 316. Calendar application 302 may provide a user interface for each user. The user interface may display a calendar stored on the database 316 to each user.

In embodiments, calendars may be created when users (e.g., user A 320 and user B 322) input a collection of event records in a database through the calendar application 302. The respective collection of even records may form user-specific calendars, meaning calendar A 304 contains event records pertaining to user A 320, and calendar B 306 contains event records pertaining to user B 322. Each event record created by the user may contain event details, e.g., attendees, time, location, attachments, and event notes as discussed in FIG. 2. Calendar A 304 and calendar B 306 may both be stored in a database 316. Database 316 may be any suitable memory bank capable of storing large amounts of data. In embodiments, database 316 is accessible by the calendar application 302, which may recall data from the database 316 as well as store data into the database 316.

Creation of an event record may be initiated by an organizer The organizer may input details of the event record into a calendar application. As shown in FIG. 3 for example, user A 320 may be the organizer for event record 308. User A may input information for the event record 308 into the calendar application 302. In this embodiment, user A 320 may input user B 322 as an attendee of event record 308, thus establishing user B 322 as an invitee. Because user B 322 is an invitee of event record 308, calendar B 200-2 may include data corresponding to event record 308.

Although FIG. 3 illustrates only two users and two calendars, other embodiments having more users are envisioned herein. For instance, system 300 may have tens, hundreds, or even thousands of users, each having their own calendar and interacting with the calendar application 302.

### III. Deleting Calendars

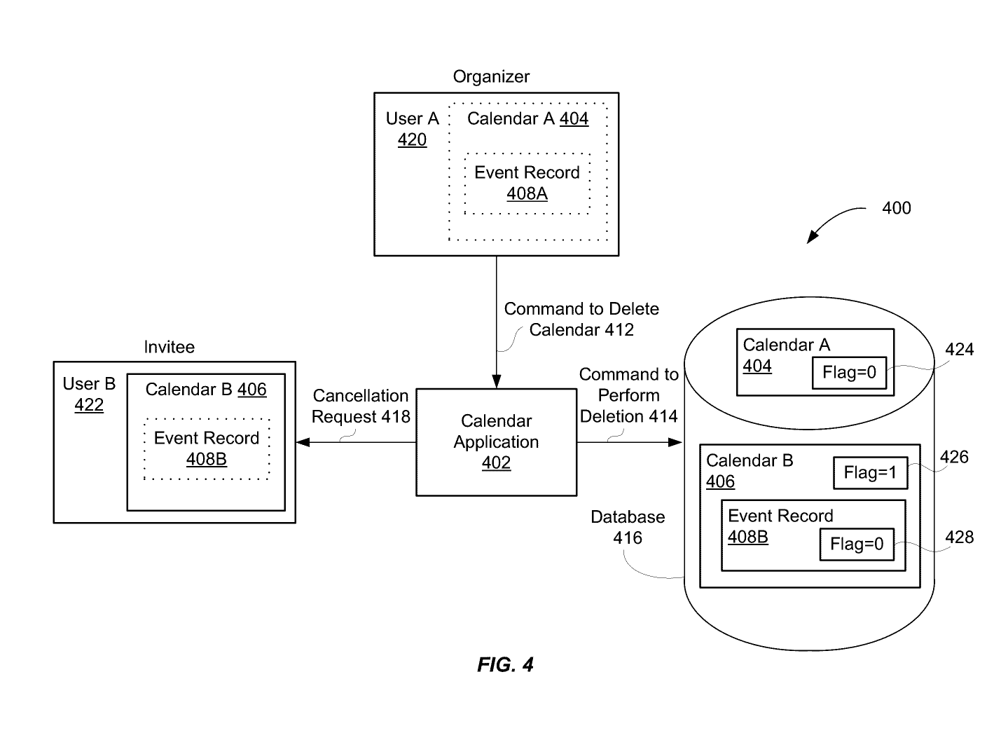

In embodiments, deleting a calendar results in a modification of the calendar. For instance, when a user deletes a calendar, the calendar application may modify the respective calendar stored within the database 316. Once modified, the calendar, in addition to the event records associated with the calendar, may be not accessible to the user. When a calendar is not accessible, users cannot edit or see the calendar and event records contained within the calendar. As such, the calendar may appear to be deleted. Modification of the calendar may be performed by marking the calendar or moving the calendar, as illustrated in FIGS. 4-6 and discussed in detail herein.

A. Deleting Calendars or Specific Events by Marking

A calendar may be deleted by marking the calendar in a database. The calendar may be marked to indicate that the calendar contains data that is to be hidden and inaccessible to a user. The marked calendar may thus appear to be deleted to the user. In embodiments, deletion may be initiated by either an organizer of an event record or an invitee of an event record.

1. Deleting by an Organizer

FIG. 4 illustrates an exemplary system 400 for deleting a calendar by marking, according to embodiments of the present invention. As illustrated, user A 420 is the organizer, e.g., the creator, of the event record 408A, and is the party seeking to delete calendar A 404. User B is an attendee of the event record 408A. Thus, calendar B 406 may include event record 408B, which is correlated with the event record 408A organized by user A 420.

In embodiments, user A 420 may initiate deletion of calendar A 404. User A 420 may initiate the deletion by interacting with a user interface of a computer to send a deletion command 412 to the calendar application 402, such as by pressing the “delete” button on the keyboard or clicking a button to delete the calendar on the computer screen. User A 420 may initiate deletion of calendar A 404 for any reason. For instance, user A 420 may initiate deletion because the calendar is not needed or obsolete. Or, user A 420 may initiate deletion for no particular reason, e.g., by accident.

Once deletion is initiated, calendar application 402 may receive the deletion command 412 from user A 420 and may mark calendar A 404 for deletion in the database 416. A command 414 to perform deletion of the calendar may be sent to the database 416 by the calendar application 402. In some embodiments, marking a calendar for deletion may be performed by changing a setting of one or more flags. The one or more flags may be a variable that can be set to indicate whether a calendar is deleted or not deleted. For instance, an existing calendar may have a flag that is set to “1,” whereas a deleted calendar may have a flag that is set to “0.” Accordingly, with reference back to FIG. 4, calendar application 402 may mark calendar A 404 as deleted by changing a flag 424 from “1” to “0.” Because calendar B 406 is not being deleted, a flag 426 for calendar B 406 may remain set to “1.”

After setting the flag to “0” for calendar A 404, the calendar application 402 may then hide calendar A 404 and its event records, e.g., 408A, from user A. In embodiments, setting the flag and hiding the calendar may be performed in any order. That is, setting the flag and hiding the calendar may be performed simultaneously, or sequentially. If sequentially, setting the flag may be performed before or after hiding the calendar. Hiding calendar A 404 removes the calendar from view and prevents accessibility to the calendar. Accordingly, when a user requests to synchronize with the database 416, user A 420 cannot see nor access calendar A 404. Calendar A 404 thus appears to be deleted.

In certain embodiments, calendar application 402 may send notifications to all attendees, e.g., user B 422, having event records in their calendars that correspond to event record 408, such as event record 408B. The notifications may include a cancellation request 418, e.g., a request to cancel event record 408B from calendar B 406. When user B 422 acknowledges the cancellation request 418, event record 408B may be hidden from calendar B 406 and a corresponding flag 428 may be set to “0” in the database 416 for the event record 408B.

In embodiments, when a calendar is deleted, the server within which database 416 is contained, may record what event records existed in the calendar at the time of deletion. Event records that were declined prior to deletion of the calendar will not be recorded by the server. Thus, when the calendar is recovered, only the event records that existed at the time of deletion will be recovered automatically, as will be discussed in detail further herein with respect to restoring calendars. Events deleted prior to the deletion of the calendar itself may be recovered separately.

A deleted calendar may include recurring event records. Recurring event records are event records that periodically repeat over a certain period of time until a last event record has occurred. Accordingly, recurring events may be treated differently than non-recurring events, i.e., a single, non-repeating event record, especially if a recurring event record is deleted prior to the occurrence of the last event record. In such embodiments, the recurring event record may be split into past event records and future event records. Future event records may be deleted, i.e., marked as deleted, but the past event records may be left intact. Past event records may not need to be marked as deleted because they have already occurred.

2. Deleting by an Invitee

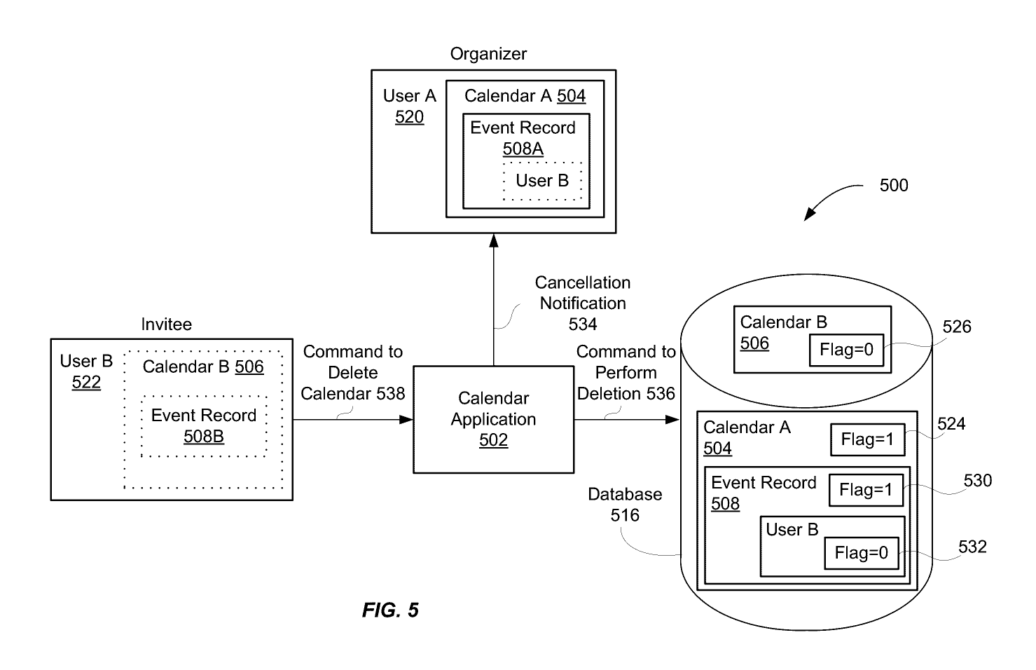

Although a calendar can be deleted by an organizer of an event record, a calendar can also be deleted by an invitee of an event record. FIG. 5 illustrates an exemplary system 500 for deleting a calendar by marking where the invitee, e.g. user B 522, is the party seeking to delete calendar B 506. Similar to FIG. 4, user A 520 is the organizer, e.g., the creator, of the event record 508A. Thus, calendar B 506 may include event record 508B, which corresponds with the event record 508A organized by user A 520.

In embodiments, when an invitee initiates deletion of a calendar, a deletion command 538 may be sent to calendar application 502. In response, calendar application 502 may send a command 536 to perform deletion of calendar B 506. Accordingly, flags 526 and 532 may be set to “0.” Calendar B 506 and its event records, e.g., 508B, may be inaccessible to users A and B. Calendar application 502 may also send a notification, such as a declined notification 534, to the organizer, user A 520, indicating that user B 522 will no longer be attending the event record 508A. Thus, user B 522 may be removed from the event record 508A.

B. Deleting Calendars by Moving

In addition to marking the calendars for deletion, other methods may be implemented to delete calendars according to embodiments of the present invention. For instance, a calendar may be moved to a server that is marked to indicate that its contents are deleted. Either an organizer or an invitee may initiate deletion by moving.

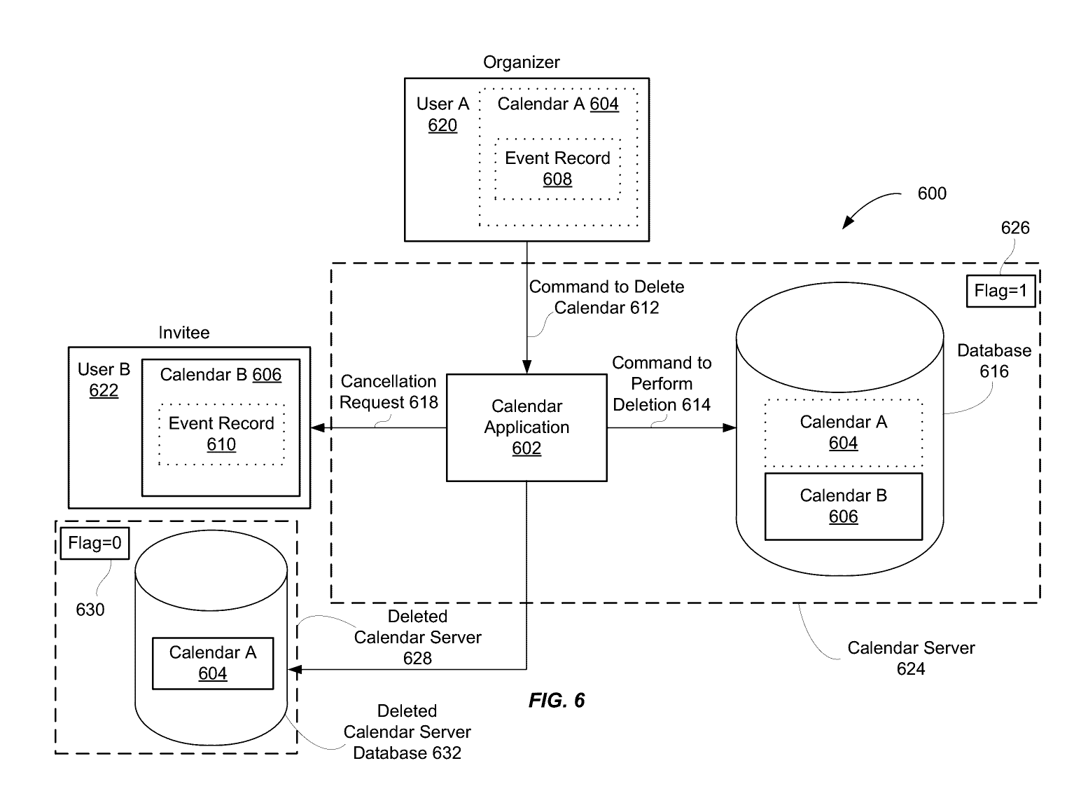

FIG. 6 illustrates a system 600 for deleting a calendar by moving the calendar to a marked server. Similar to FIG. 4, system 600 includes an organizer, i.e., user A 620, and an invitee, i.e., user B 622. Both users may each have their own calendar: calendar A 604 and calendar B 606, respectively. In embodiments, calendar application 602 and database 616 may both be located in a calendar server 624. Calendar server 624 may be a server that is accessible to clients A and B through the calendar application 602. For instance, the calendar server 624 may be a local server. In embodiments, calendar server 624 may be marked to indicate that the data stored within it are existing applications. For instance, calendar server 624 may be marked by a flag 626 that is set to “1,” as already discussed herein. Thus, any application or data stored on the calendar server 624 may be visible and accessible to users A and B.

When user A initiates deletion of calendar A 604, calendar application 602 may receive a deletion command 612. In response, calendar application 602 may move calendar A 604 to a different server. As an example, calendar application 602 may move calendar A 604 to a deleted calendar server 628. In an embodiment, deleted calendar server 628 is a remote server located a substantial distance away from the calendar server 624. Deleted calendar server 628 may be marked with a flag 630 that is set to “0” for reasons already discussed herein. In embodiments, deleted calendar server 628 may contain a deleted calendar server database 632 containing memory for storing data that is to be hidden and not accessible to users. Accordingly, any application or data stored on the deleted calendar server 624 may be hidden and not accessible to users A and B.

Although FIGS. 4-6 illustrate deletion of calendars, deletion of other collections of data may be envisioned herein as well. For instance, instead of deleting an entire calendar, a portion of the calendar can be deleted, such as just one or more event records of the calendar. Thus, disclosures pertaining to calendars herein may also be applied to event records.

### IV. Updating Deleted Calendars

Even though a calendar is deleted by a user (e.g., flagged as deleted and hidden from users), the calendar may still be updated as if it were not deleted at all. This circumstance may be applicable to instances where an invitee deletes a calendar or an event record created by an organizer.

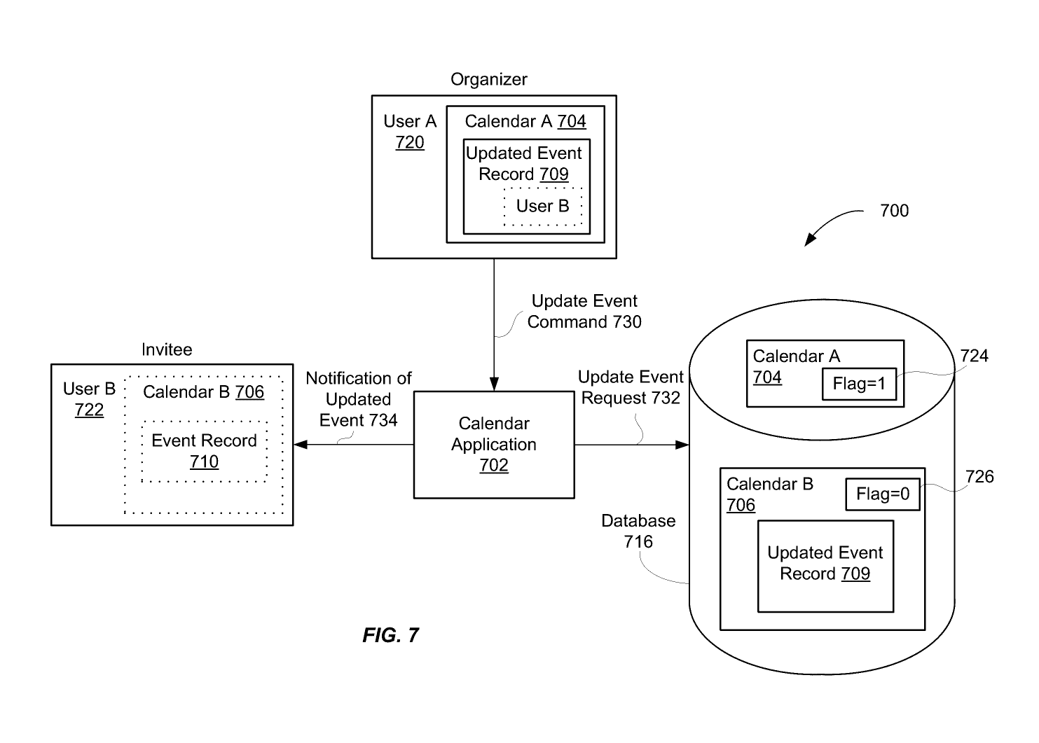

FIG. 7 illustrates an example system 700 for updating a deleted calendar. As shown, user A 720 may be an organizer for event record 708B, of which user B 722 is an attendee. Database 716 may contain calendar A 704 and calendar B 706, which may be marked by flags 724 and 726, respectively. Calendar B 706 may be deleted by user B 722; thus, flag 726 may be set to “0” and inaccessible to user B 722.

In embodiments, user A 720 may update event record 708A (not shown), thus creating updated event record 709. For instance, user A 720 may change the location or time of the event record 708A. The resulting event record may be updated event record 709. Calendar application 702 may receive an update event command 730 from user A 720. In response, calendar application 702 may include the updated event record 709 in calendar B 706 in the database 716 by sending an update event request 732. Even though the flag 726 is set to “0,” indicating that calendar B 706 is deleted and inaccessible to user B 722, user A 720, via calendar application 702, may still edit the contents of calendar B 706. In an embodiment, the old event record, i.e., event record 708A (not shown), may be permanently deleted, meaning removed from a server such that it cannot be recovered.

In certain embodiments, when updated event record 709 is included in database 716, a notification 734 may be sent to user B 722. Notification 734 may indicate that the deleted event record, i.e., event record 708B which may be associated with 708A, has been updated by the organizer user A 720. Notification 734 may include details as to what the changes are such that user B 722 may be aware of the new meeting details. Additionally, notification 734 may prompt user B 722 with an option to recover calendar B 706 with the updated event record 709, or to recover only the updated event record 709. This may be particularly useful if user B 722 deleted event record 708B because the initial meeting location or time was not favorable to him or her, and that the updated event record 709 included a changed meeting time or location that is now more favorable. Thus, user B 722 may personally recover calendar B 706 or updated event record 709, as will be discussed further herein.

### V. Restoring Deleted Calendars

Deleted calendars and event records may be recovered so that the calendar can be made visible and accessible to a user. The recovered calendars and event records may contain changes made by organizer users when they were marked as deleted and hidden from view. In embodiments, restoration of calendars may be performed by the user that initially deleted the calendar. Thus, deleted calendars may be easily recovered without having to contact IT, and may be recovered in a fraction of the time it would have taken if recovered by IT.

A. Restoring Calendars by Marking

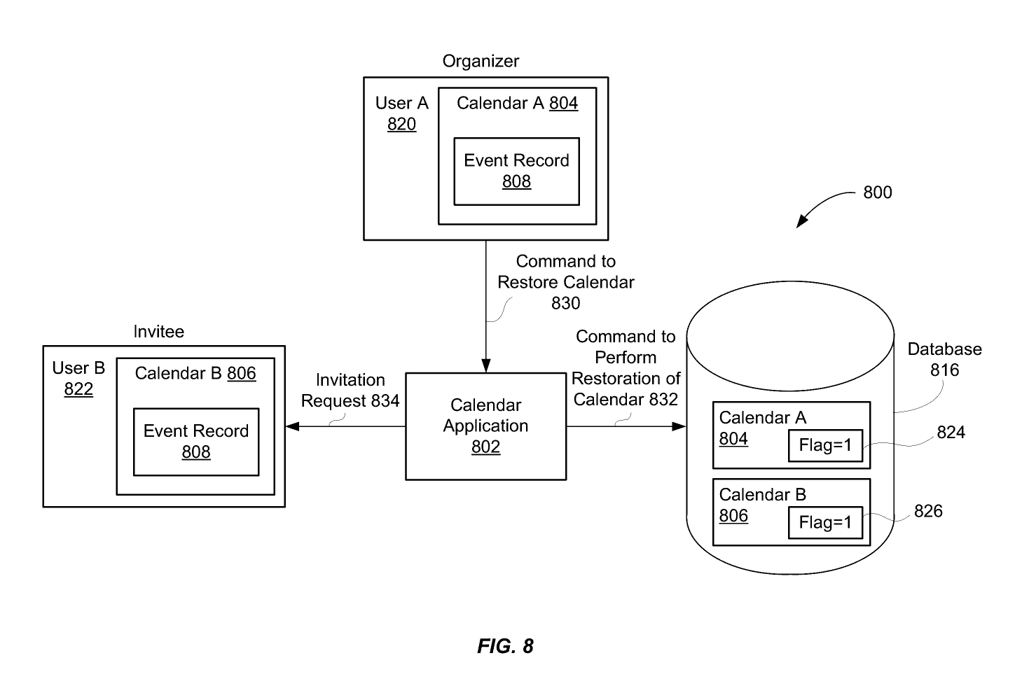

FIG. 8 illustrates a system 800 for restoring a calendar by marking according to embodiments of the present invention. FIG. 8 may continue from FIG. 4 discussed herein. Accordingly, FIG. 8 may have the same setup as FIG. 4.

User A 820 may recover calendar A 804 by sending a command 830 to calendar application 802. Any suitable indication by user A 820 may initiate sending of command 802 to calendar application 802. For instance, user A 820 may click “recover” in a web browser on his or her computer while selecting calendar A 804. Or, user A 820 may click and drag calendar A 804 from a web browser to his or her computer to recover calendar A 804.

Calendar application 802 may receive restoration command 830 and send a command 832 to perform restoration of calendar A 804. In embodiments, command 832 changes the setting of flag 824 of calendar A 804 from “0” to “1,” indicating that calendar A 804 is now undeleted. With flag 824 set to “1,” calendar A 804 may be un-hidden and accessible to user A 820. All event records, such as event record 808, that are contained within calendar A 804 may also be recovered. Thus, when user A 820 synchronizes his computer with database 816, calendar A 804 may appear. In an embodiments, user A 820 receives a notification from calendar application 802 indicating that calendar A 804 has been recovered. User A 820 may then send a request to the calendar application to synchronize his user interface with the database 816 to have calendar A 804 re-appear.

Once calendar A 804 is recovered, calendar application 802 may send invitation requests 834 to all attendees for each event record, e.g., event record 808, contained in calendar A 804. In embodiments, attendees who originally accepted the invitation to attend the event record may receive invitation requests 834. Invitation request 834 may prompt the attendee to accept the meeting once again. In some embodiments, calendar application 802 may take a step further and automatically accept the invitation for those attendees. Such embodiments assume that because the event record was accepted the first time, the attendee will likely accept the meeting again. Along the same logic, calendar application 802 may not send invitation requests 834 to those attendees who originally declined to attend event record 808. Because the attendee declined the original event record, he or she is likely to decline the recovered event record again. Accordingly, attendees may have their participation statues (e.g., declined/accepted/tentative) set back to what it was at the time the calendar was deleted.

In embodiments where the recovered event record is a recurring event, only the future recurring events may be recovered. Thus, invitation requests 834 may be sent to the attendees for the future recurring events, not the past recurring events.

In some embodiments, calendar application 802 may allow a user to change the recovered calendar prior to sending out the invitation request 834. For instance, once calendar A 804 is recovered, calendar application 802 may send a notification to user A 820 asking whether a change needs to be made to calendar A 804. If user A 820 would like to change event record 808, user A 820 may respond affirmatively, indicating that he or she would like to edit event record 808. Calendar application 802 may then allow user A 820 to change event record 808 of calendar A 804. Once event record 808 has been edited, calendar application 802 may then send the invitation request 806 for the edited event record 808 to the attendees, such as user B 822.

B. Restoring Calendars by Moving

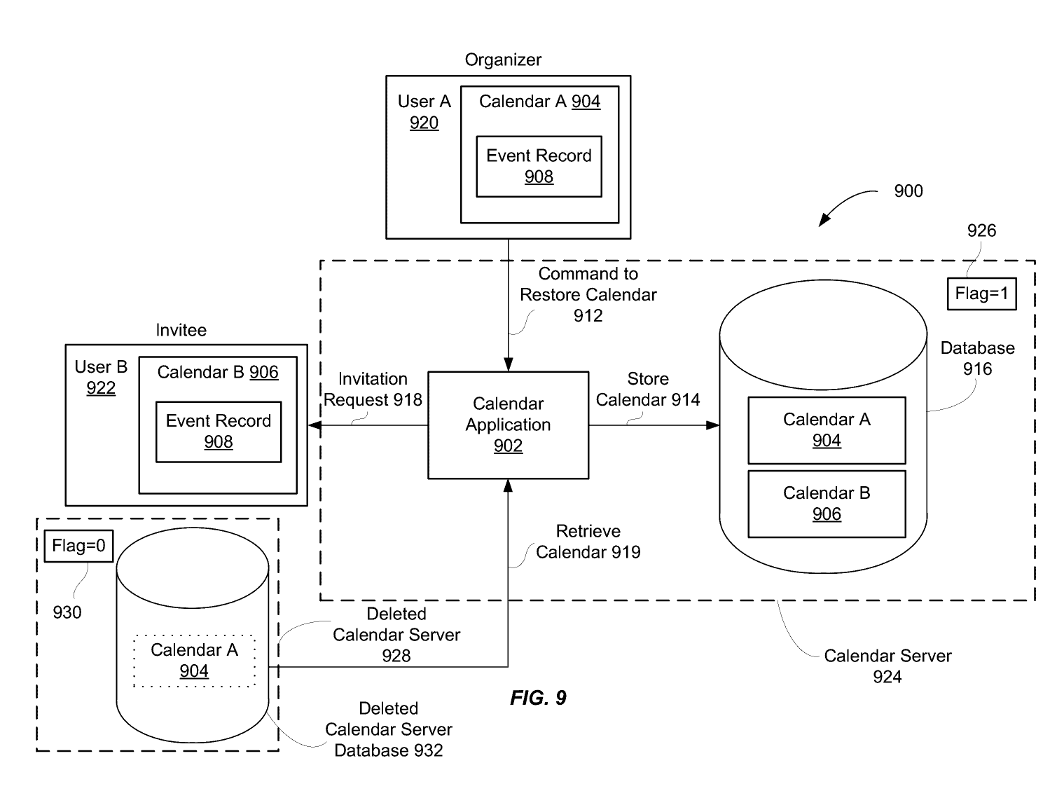

FIG. 9, illustrates a system 900 for restoring deleted calendar A 904 by moving, according to an embodiment of the present invention. FIG. 9 may continue from FIG. 6, and may thus have a similar setup.

With brief reference to FIG. 9, once calendar application 902 receives a request 912 to recover calendar A 904, calendar application 902 may retrieve 919 calendar A 904 from the deleted calendar server database 932 and store 914 calendar A 904 back into database 916. Database 916 may be marked with a flag 926 set to “1” indicating that calendar A 904 is not deleted and is thus un-hidden and accessible to user A 920.

One skilled in the art understands that although FIGS. 8 and 9 illustrate restoring an entire calendar, a portion of the calendar may be recovered according to embodiments discussed herein as well. For instance, one or more event records may be recovered instead of the entire calendar.

C. Restoring Based on Priority

In embodiments, restoration of a calendar may be a straight-forward operation where the calendar and all of its event records are reinstated. However, it is likely that a period of time has elapsed from when the calendar was initially deleted until when the calendar is recovered. During that period of time, a user, e.g., an attendee of the event record prior to deletion, may have accepted an invitation to another event record that conflicts with the event record that is seeking to be recovered. Thus, restoration of an event record may be performed according to certain priorities.

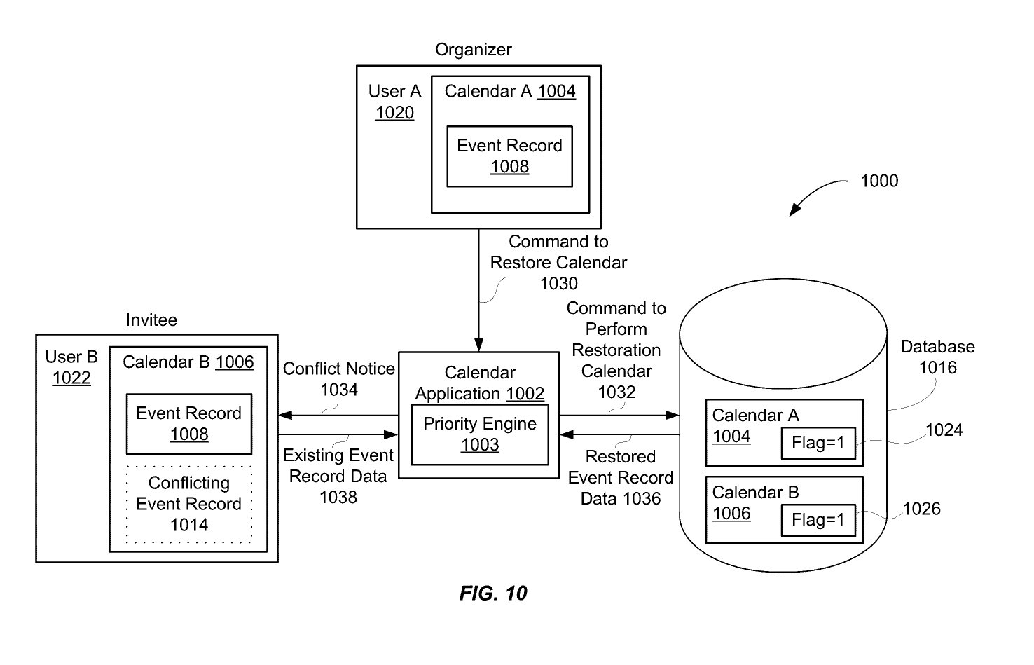

FIG. 10 illustrates a system 1000 for restoring a deleted calendar based upon priority according to an embodiment of the present invention. System 1000 includes a user A 1020 and a user B 1022. User A 1020 may be an organizer of an event record 1008, and user B 1022 may be an invitee of the event record 1008. Accordingly, event record 1008 may be visible to user A 1020 and user B 1022 in calendar A 1004 and calendar B 1006, respectively. Calendar A 1004 and calendar B 1006 may be stored in a database 1016 accessible by users A and B through calendar application 1002. Calendar application 1002 may be run by computers of both user A and user B, and may contain priority engine 1003. Priority engine 1003 may be computer code implementing an algorithm for determining which conflicting event record has priority over the other.

As illustrated in FIG. 10, user A 1020 may initiate a sending of a command 1030 to recover calendar A 1004. The request 1030 may be received by calendar application 1002, which may, in response, send a command 1032 to perform restoration of calendar A 1004. Once calendar A 1004 is marked as undeleted, priority engine 1003 may gather recovered event record data 1036 from the recovered calendar A 1004, as well as existing event record data 1038 from existing calendar B 1006. Recovered event record data 1036 may include information about each event record that is being recovered. Existing event record data 1038 may include information about each existing event record in calendar B 1006. Thereafter, priority engine 1003 may compare the recovered event record data 1036 to the existing event record data 1038 to determine whether an event record that is being recovered conflicts with an existing event record.

An event record may conflict with another event record if both event records contain identical information, e.g., identical time and/or location, such that an attendee cannot attend both event records. For instance, if a recovered event record is a meeting that is to take place at time A, and an existing event record is a meeting that is also to take place at time A, then the first and second event records conflict with one another because both event records are to be held at the same time. As shown in FIG. 10, conflicting event record 1014 may conflict with event record 1008.

In embodiments, if a conflict exists, then the calendar application 1002 may notify the respective user of the conflict. For instance, if event record 1008 conflicts with conflicting event record 1014, then calendar application 1002 may send a conflict notice 1034 to user B 1022. The notice may indicate that there is a scheduling conflict and may prompt user B 1022 to select which event record he would like to keep in calendar B 1006.

Alternatively, if a conflict exists, priority engine 1003 may automatically determine which event has priority over the other and automatically delete the event record that is lower priority. For instance, if event record 1008 has priority over conflicting event record 1014, event record 1008 may remain in calendar B 1006. In an embodiment, conflicting event record 1014 may be deleted by calendar application 1002 such that conflicting event record 1014 is hidden from and not accessible to user B 1022. Upon deleting the event record 1014, a notification may be given to user B 1022 indicating that event record 1014 is being deleted. Furthermore, another notification may be sent to the organizer of event record 1014, indicating that user B 1022 is no longer participating in the meeting. If user B 1022 is the organizer of event record 1014, then notifications may be given to each attendee of the event record 1014 indicating that the event is cancelled or changed.

In embodiments, priority may be based upon any criteria. For instance, priority may be based upon time or attendees. An event record may have priority over another event record based upon when the event record was created. For instance, if an event record was created before a conflicting event record, then the earlier event record may be given priority over the other.

Additionally, an event record may have priority over another event record based upon who is attending the event record. For instance, if an event record has a person of importance, e.g., an executive, a CEO, a boss, etc., and the conflicting event record does not, then the event record with the person of importance may be given priority over the other.

It is to be appreciated that these embodiments are merely examples of certain criteria that may be used to establish priority, and are not intended to be limiting.

### VI. Method of Undeleting a Calendar

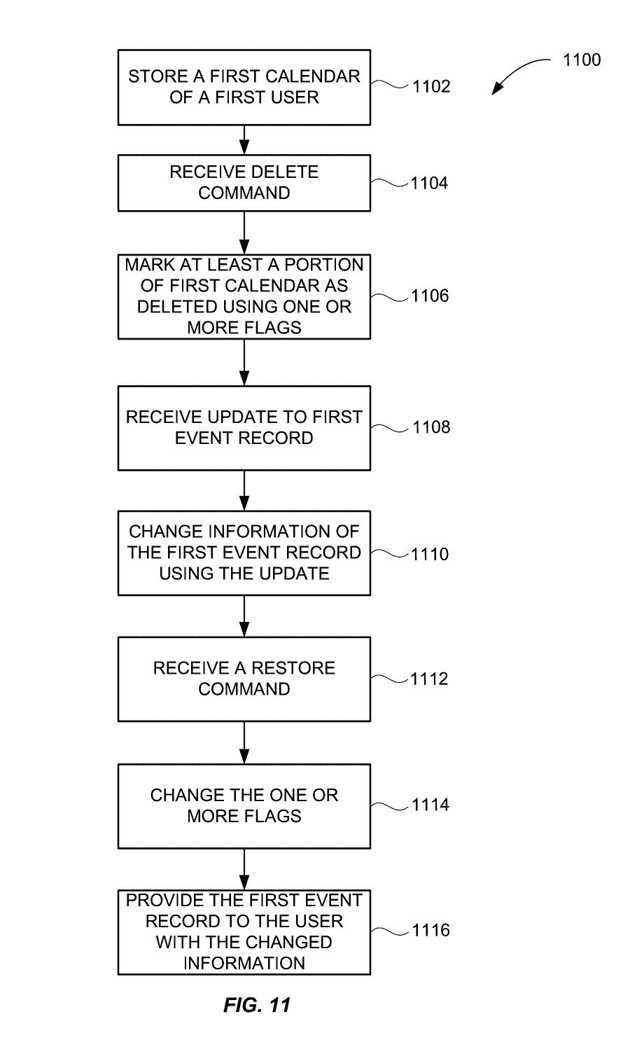

FIG. 11 is a flow chart illustrating a method 1100 of undeleting a calendar according to embodiments of the present invention. Method 1100 can be performed entirely or partially by a calendar application, such as the calendar application 302 discussed herein.

At block 1102, a first calendar of a first user may be stored in a database system. The first calendar may include a plurality of event records. Each event record may be associated with an event, such as a meeting, an appointment, etc. Further, each event record may include information about the event, such as an event location, event attendees, and an event time. The first calendar may be stored by the calendar application.

At block 1104, a delete command may be received by the calendar application. In an embodiment, a user interacts with a user interface on a computer to send the delete command to the calendar application.

At block 1106, at least a portion of the first calendar is marked as deleted in the database system. One or more flags may be used to mark the first calendar as deleted. For instance, the one or more flags may be set to “0” from “1” to indicate that the first calendar is deleted. When marked, the at least a portion of the first calendar is hidden and not accessible by the user such that the first calendar appears to be deleted. In other embodiments, the at least a portion of the first calendar may be marked as deleted by moving the at least a portion of the first calendar to a separate server. The separate server may be marked with one or more flags set to “0” to indicate that data stored on the separate server are to be treated as deleted.

At block 1108, an update to a first event record of the at least a portion of the first calendar marked as deleted may be received. The update may be received after marking the at least a portion of the first calendar as deleted. In embodiments, the update may be received in response to a change made to a second event record of a second calendar of a second user. The second event record may correspond to the first event record. In certain embodiments, the change made to the second event record may be to the event location, event attendees, and/or the event time of the second even record.

At block 1110, the information of the first event record may be changed using the update. For instance, the first event record may be changed according to the event location, event attendees, and/or the event time of the second event record.

At block 1112, a recover command may be received by the calendar application to recover the at least a portion of the first calendar. The recover command may be initiated by the user who initiated deletion of the calendar, such as the first user.

At block 1114, once the recover command is received, the calendar application may change the one or more flags to indicate that the at least a portion of the first calendar is not deleted. For instance, the one or more flags may be set from “0” back to “1” to indicate that the at least a portion of the first calendar is not deleted. The user may therefore access the calendar.

At block 1116, the first event record may be provided to the first user with the changed information. In embodiments, the first event record may be provided in response to a request to view the first event record. The request may be sent by the first user.

### VII. Example Device

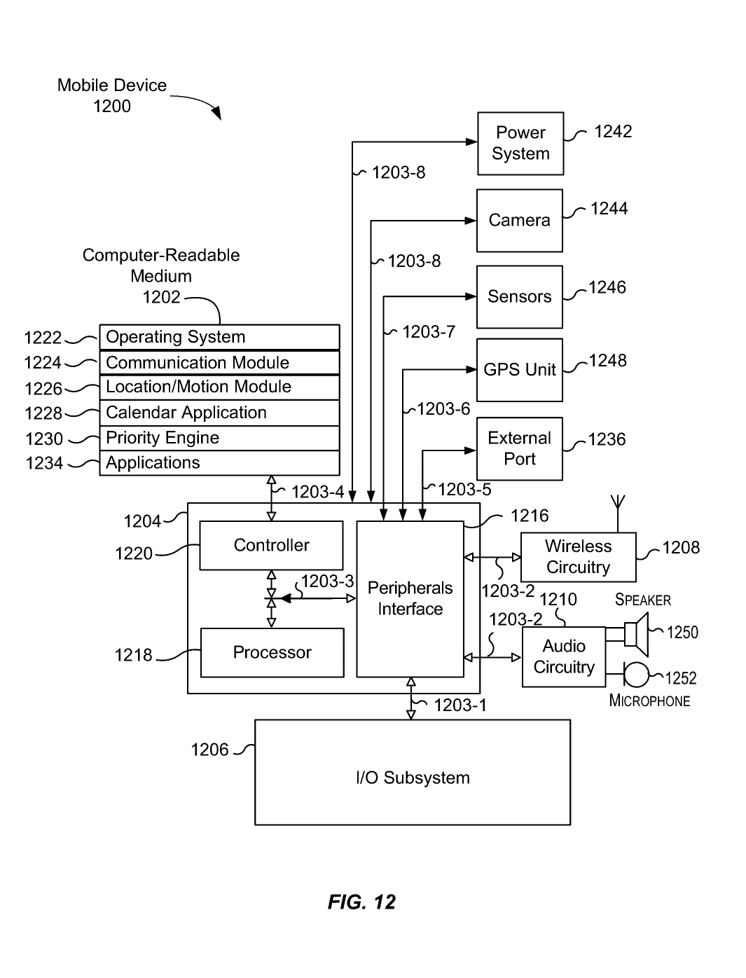

FIG. 12 is a block diagram of an example device 1200, which may be a mobile device. Device 1200 generally includes computer-readable medium 1202, a processing system 1204, an Input/Output (I/O) subsystem 1206, wireless circuitry 1208, and audio circuitry 1210 including speaker 1250 and microphone 1252. These components may be coupled by one or more communication buses or signal lines 1203. Device 1200 can be any portable electronic device, including a handheld computer, a tablet computer, a mobile phone, laptop computer, tablet device, media player, personal digital assistant (PDA), a key fob, a car key, an access card, a multi-function device, a mobile phone, a portable gaming device, or the like, including a combination of two or more of these items.

It should be apparent that the architecture shown in FIG. 12 is only one example of an architecture for device 1200, and that device 1200 can have more or fewer components than shown, or a different configuration of components. The various components shown in FIG. 12 can be implemented in hardware, software, or a combination of both hardware and software, including one or more signal processing and/or application specific integrated circuits.

Wireless circuitry 1208 is used to send and receive information over a wireless link or network to one or more other devices' conventional circuitry such as an antenna system, an RF transceiver, one or more amplifiers, a tuner, one or more oscillators, a digital signal processor, a CODEC chipset, memory, etc. Wireless circuitry 1208 can use various protocols, e.g., as described herein.

Wireless circuitry 1208 is coupled to processing system 1204 via peripherals interface 1216. Interface 1216 can include conventional components for establishing and maintaining communication between peripherals and processing system 1204. Voice and data information received by wireless circuitry 1208 (e.g., in speech recognition or voice command applications) is sent to one or more processors 1218 via peripherals interface 1216. One or more processors 1218 are configurable to process various data formats for one or more application programs 1234 stored on medium 1202.

Peripherals interface 1216 couple the input and output peripherals of the device to processor 1218 and computer-readable medium 1202. One or more processors 1218 communicate with computer-readable medium 1202 via a controller 1220. Computer-readable medium 1202 can be any device or medium that can store code and/or data for use by one or more processors 1218. Medium 1202 can include a memory hierarchy, including cache, main memory and secondary memory.

Device 1200 also includes a power system 1242 for powering the various hardware components. Power system 1242 can include a power management system, one or more power sources (e.g., battery, alternating current (AC)), a recharging system, a power failure detection circuit, a power converter or inverter, a power status indicator (e.g., a light emitting diode (LED)) and any other components typically associated with the generation, management and distribution of power in mobile devices.

In some embodiments, device 1200 includes a camera 1244. In some embodiments, device 1200 includes sensors 1246. Sensors can include accelerometers, compass, gyrometer, pressure sensors, audio sensors, light sensors, barometers, and the like. Sensors 1246 can be used to sense location aspects, such as auditory or light signatures of a location.

In some embodiments, device 1200 can include a GPS receiver, sometimes referred to as a GPS unit 1248. A mobile device can use a satellite navigation system, such as the Global Positioning System (GPS), to obtain position information, timing information, altitude, or other navigation information. During operation, the GPS unit can receive signals from GPS satellites orbiting the Earth. The GPS unit analyzes the signals to make a transit time and distance estimation. The GPS unit can determine the current position (current location) of the mobile device. Based on these estimations, the mobile device can determine a location fix, altitude, and/or current speed. A location fix can be geographical coordinates such as latitudinal and longitudinal information.

One or more processors 1218 run various software components stored in medium 1202 to perform various functions for device 1200. In some embodiments, the software components include an operating system 1222, a communication module (or set of instructions) 1224, a location module (or set of instructions) 1226, a calendar application 1228, a priority module 1230, and other applications (or set of instructions) 1234, such as a car locator app and a navigation app.

Operating system 1222 can be any suitable operating system, including iOS, Mac OS, Darwin, RTXC, LINUX, UNIX, OS X, WINDOWS, or an embedded operating system such as VxWorks. The operating system can include various procedures, sets of instructions, software components and/or drivers for controlling and managing general system tasks (e.g., memory management, storage device control, power management, etc.) and facilitates communication between various hardware and software components.

Communication module 1224 facilitates communication with other devices over one or more external ports 1236 or via wireless circuitry 1208 and includes various software components for handling data received from wireless circuitry 1208 and/or external port 1236. External port 1236 (e.g., USB, FireWire, Lightning connector, 60-pin connector, etc.) is adapted for coupling directly to other devices or indirectly over a network (e.g., the Internet, wireless LAN, etc.).

Location/motion module 1226 can assist in determining the current position (e.g., coordinates or other geographic location identifier) and motion of device 1200. Modern positioning systems include satellite based positioning systems, such as Global Positioning System (GPS), cellular network positioning based on “cell IDs,” and Wi-Fi positioning technology based on a Wi-Fi networks. GPS also relies on the visibility of multiple satellites to determine a position estimate, which may not be visible (or have weak signals) indoors or in “urban canyons.” In some embodiments, location/motion module 1226 receives data from GPS unit 1248 and analyzes the signals to determine the current position of the mobile device. In some embodiments, location/motion module 721226 can determine a current location using Wi-Fi or cellular location technology. For example, the location of the mobile device can be estimated using knowledge of nearby cell sites and/or Wi-Fi access points with knowledge also of their locations. Information identifying the Wi-Fi or cellular transmitter is received at wireless circuitry 1208 and is passed to location/motion module 1226. In some embodiments, the location module receives the one or more transmitter IDs. In some embodiments, a sequence of transmitter IDs can be compared with a reference database (e.g., Cell ID database, Wi-Fi reference database) that maps or correlates the transmitter IDs to position coordinates of corresponding transmitters, and computes estimated position coordinates for device 1200 based on the position coordinates of the corresponding transmitters. Regardless of the specific location technology used, location/motion module 1226 receives information from which a location fix can be derived, interprets that information, and returns location information, such as geographic coordinates, latitude/longitude, or other location fix data.

Calendar application 1228 can include computer code for deleting and restoring calendars, e.g., as described herein with respect to FIGS. 3-10. Furthermore, priority engine 1230 can include computer code for implementing an algorithm to determine priorities of event records, e.g., as described herein with respect to FIG. 10.

The one or more applications 1234 on the mobile device can include any applications installed on the device 1200, including without limitation, a browser, address book, contact list, email, instant messaging, word processing, keyboard emulation, widgets, JAVA-enabled applications, encryption, digital rights management, voice recognition, voice replication, a music player (which plays back recorded music stored in one or more files, such as MP3 or AAC files), etc.

There may be other modules or sets of instructions (not shown), such as a graphics module, a time module, etc. For example, the graphics module can include various conventional software components for rendering, animating and displaying graphical objects (including without limitation text, web pages, icons, digital images, animations and the like) on a display surface. In another example, a timer module can be a software timer. The timer module can also be implemented in hardware. The time module can maintain various timers for any number of events.

The I/O subsystem 1206 can be coupled to a display system (not shown), which can be a touch-sensitive display. The display displays visual output to the user in a GUI. The visual output can include text, graphics, video, and any combination thereof. Some or all of the visual output can correspond to user-interface objects. A display can use LED (light emitting diode), LCD (liquid crystal display) technology, or LPD (light emitting polymer display) technology, although other display technologies can be used in other embodiments.

In some embodiments, I/O subsystem 1206 can include a display and user input devices such as a keyboard, mouse, and/or track pad. In some embodiments, I/O subsystem 1206 can include a touch-sensitive display. A touch-sensitive display can also accept input from the user based on haptic and/or tactile contact. In some embodiments, a touch-sensitive display forms a touch-sensitive surface that accepts user input. The touch-sensitive display/surface (along with any associated modules and/or sets of instructions in medium 1202) detects contact (and any movement or release of the contact) on the touch-sensitive display and converts the detected contact into interaction with user-interface objects, such as one or more soft keys, that are displayed on the touch screen when the contact occurs. In some embodiments, a point of contact between the touch-sensitive display and the user corresponds to one or more digits of the user. The user can make contact with the touch-sensitive display using any suitable object or appendage, such as a stylus, pen, finger, and so forth. A touch-sensitive display surface can detect contact and any movement or release thereof using any suitable touch sensitivity technologies, including capacitive, resistive, infrared, and surface acoustic wave technologies, as well as other proximity sensor arrays or other elements for determining one or more points of contact with the touch-sensitive display.

Further, the I/O subsystem can be coupled to one or more other physical control devices (not shown), such as pushbuttons, keys, switches, rocker buttons, dials, slider switches, sticks, LEDs, etc., for controlling or performing various functions, such as power control, speaker volume control, ring tone loudness, keyboard input, scrolling, hold, menu, screen lock, clearing and ending communications and the like. In some embodiments, in addition to the touch screen, device 1200 can include a touchpad (not shown) for activating or deactivating particular functions. In some embodiments, the touchpad is a touch-sensitive area of the device that, unlike the touch screen, does not display visual output. The touchpad can be a touch-sensitive surface that is separate from the touch-sensitive display or an extension of the touch-sensitive surface formed by the touch-sensitive display.

In some embodiments, some or all of the operations described herein can be performed using an application executing on the user's device. Circuits, logic modules, processors, and/or other components may be configured to perform various operations described herein. Those skilled in the art will appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Computer programs incorporating various features of the present invention may be encoded on various computer readable storage media; suitable media include magnetic disk or tape, optical storage media such as compact disk (CD) or DVD (digital versatile disk), flash memory, and the like. Computer readable storage media encoded with the program code may be packaged with a compatible device or provided separately from other devices. In addition program code may be encoded and transmitted via wired optical, and/or wireless networks conforming to a variety of protocols, including the Internet, thereby allowing distribution, e.g., via Internet download. Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

Although the invention has been described with respect to specific embodiments, it will be appreciated that the invention is intended to cover all modifications and equivalents within the scope of the following claims.

What is claimed is:

1. A method for recovering a deleted calendar, the method comprising, at a computer system:
storing a first calendar of a first user including a plurality of event records in a database system, each of the plurality of event records comprising information about an event location, event attendees, and an event time;
receiving a delete command to delete at least a portion of the first calendar;
marking, in the database system, the at least a portion of the first calendar as deleted using one or more flags such that the at least a portion of the first calendar is not accessible to the first user;
after marking the at least a portion of the first calendar as deleted:
receiving an update to a first event record of the at least a portion of the first calendar marked as deleted, the update received in response to a change made to a second event record of a second calendar of a second user, wherein the second event record corresponds to the first event record; and
changing the information of the first event record using the update such that the first event record includes changed information;
receiving a recover command to recover the at least a portion of the first calendar;
changing the one or more flags to indicate that the at least a portion of the first calendar is not deleted; and
in response to a request to view the first event record, providing the first event record to the first user with the changed information.

2. The method of claim 1, further comprising, at the computer system:
after marking the at least a portion of the first calendar as deleted, sending a notification to the second user indicating that the first user is not attending the first event record.

3. The method of claim 1, further comprising, at the computer system:
after changing the information of the first event record using the update, sending a notification to the first user indicating that the information of the first event record has been changed.

4. The method of claim 3, wherein the notification includes a prompt allowing the first user to send the recover command to recover the at least a portion of the first calendar.

5. The method of claim 1, wherein marking the at least a portion of the first calendar as deleted comprises:
changing the one or more flags to indicate that the at least a portion of the first calendar is deleted.

6. The method of claim 1, wherein the recover command is sent by the first user.

7. The method of claim 1, wherein the at least a portion of the first calendar comprises one or more event records.

8. The method of claim 1, wherein marking the at least a portion of the first calendar as deleted comprises moving the at least a portion of the first calendar to a different server, wherein the different server is marked as deleted with the one or more flags.

9. A computer product comprising a non-transitory computer readable medium storing a plurality of instructions that when executed control a device including one or more processors, the plurality of instructions comprising:
storing a first calendar of a first user including a plurality of event records in a database system, each of the plurality of event records comprising information about an event location, event attendees, and an event time;
receiving a delete command to delete at least a portion of the first calendar;
marking, in the database system, the at least a portion of the first calendar as deleted using one or more flags such that the at least a portion of the first calendar is not accessible to the first user;
after marking the at least a portion of the first calendar as deleted:
receiving an update to a first event record of the at least a portion of the first calendar marked as deleted, the update received in response to a change made to a second event record of a second calendar of a second user, wherein the second event record corresponds to the first event record; and
changing the information of the first event record using the update such that the first event record includes changed information;
receiving a recover command to recover the at least a portion of the first calendar;
changing the one or more flags to indicate that the at least a portion of the first calendar is not deleted; and
in response to a request to view the first event record, providing the first event record to the first user with the changed information.

10. The computer product of claim 9, wherein the instructions further comprise:
after marking the at least a portion of the first calendar as deleted, sending a notification to the second user indicating that the first user is not attending the first event record.

11. The computer product of claim 9, wherein the instructions further comprise:
after changing the information of the first event record using the update, sending a notification to the first user indicating that the information of the first event record has been changed.

12. The computer product of claim 11, wherein the notification includes a prompt allowing the first user to send the recover command to recover the at least a portion of the first calendar.

13. The computer product of claim 9, wherein the recover command is sent by the first user.

14. A device comprising:
a first database system for storing calendars; and
one or more processors configured to:
store a first calendar of a first user including a plurality of event records in the first database system, each of the plurality of event records comprising information about an event location, event attendees, and an event time;
receive a delete command to delete at least a portion of the first calendar;
mark, in the first database system, the at least a portion of the first calendar as deleted using one or more flags such that the at least a portion of the first calendar is not accessible to the first user;
after marking the at least a portion of the first calendar as deleted:
receive an update to a first event record of the at least a portion of the first calendar marked as deleted, the update received in response to a change made to a second event record of a second calendar of a second user, wherein the second event record corresponds to the first event record; and
change the information of the first event record using the update such that the first event record includes changed information;
receive a recover command to recover the at least a portion of the first calendar;
change the one or more flags to indicate that the at least a portion of the first calendar is not deleted; and
in response to a request to view the first event record, provide the first event record to the first user with the changed information.

15. The device of claim 14, further comprising:
a second database for storing deleted calendars, the second database being located on a server different than the first database system is stored.

16. The device of claim 15, wherein marking the at least a portion of the first calendar as deleted comprises moving the at least a portion of the first calendar to the first database system, and wherein the first database system is located in a local server marked with the one or more flags.

17. The device of claim 14, wherein the one or more processors are further configured to:
after marking the at least a portion of the first calendar as deleted, send a notification to the second user indicating that the first user is not attending the first event record.

18. The device of claim 14, wherein the one or more processors are further configured to:
after changing the information of the first event record using the update, send a notification to the first user indicating that the information of the first event record has been changed.

19. The device of claim 18, wherein the notification includes a prompt allowing the first user to send the recover command to recover the at least a portion of the first calendar.

20. The device of claim 14, wherein the recover command is sent by the first user.
